(19) United States
(12) Patent Application Publication
(10) Pub. No.: US 2005/0075895 A1
(43) Pub. Date: Apr. 7, 2005

(54) Method for storing and retrieving digital images with a service provider

(76) Inventors: Kamran Mohsenin, Albany, CA (US); Hari Vasudev, Milpitas, CA (US); Mark Johns, San Francisco, CA (US)

Correspondence Address: Milton S. Sales;Patent Legal Staff, Eastman Kodak Company, 343 State Street, Rochester, NY, 14650-2201, US

(21) Appl. No.: 10/679,713

(22) Filed: Oct. 6, 2003

(51) Int. Cl. G06F 17/60

(52) U.S. Cl. 705/1

(57) ABSTRACT

A method for storing and retrieving digital media received from a sending device of a user by a service provider. The service provider has a database for storing of digital media with respect to the associated customer account. The image provider examines a message associated with the digital media so as to obtain a sender ID and them searches the database to determine if the ID is associated with one of the customer accounts. The digital media is forwarded to the database if the associated customer account exists. However, if no associated customer account exists, a temporary account is established and the digital media is stored on database. A PIN is associated with respect to the temporary account and is forwarded to the user for use in accessing the stored digital media.

### FIELD OF THE INVENTION

The present invention relates to forwarding and storing images at an image provider on behalf of a customer for later retrieval and access.

### BACKGROUND OF THE INVENTION

There are numerous digital devices that are capable of capturing and/or storing digital images. Examples of such devices are digital cameras, camera phones, and PDAs (personal display devices). A problem with such devices is that they have limited capabilities and storage space. Users of these devices often find that they need to make use of a service provider in order to store, manage and/or print their digital images. In order for a user to utilize such a service provider, the user must first create an account with that service provider which is a task often best performed on a personal computer or other similar type device. However, because these devices are easily portable, the users of such devices usually only realize they need such a service provider when they are using the device away from a personal computer. For example, they are out taking pictures with their camera phone at an event wherein one or two digital images can quickly take up all or most of the memory provided on the device. If the event is taking place at a park, arena or other non-connected location, a personal computer or other device may not be capable or available for transmission of images to the remote service provider. Additionally, there are situations when time is of extreme importance. Even if one is capable of accessing a remote service provider, if the user is not a current subscriber, there may not be enough time to set up an account for normal routine entries, yet the user may need or desire to transfer the images to a service provider

The present invention provides a method and system for allowing a user to be able send digital images to a specified image provider, without requiring that the user have prior account with that provider. A few or as many digital images can be sent at a single time or a plurality of different times and still be available to the user at a later point and time when sufficient time is available for accessing or setting up a user account.

### SUMMARY OF THE INVENTION

In accordance with one aspect of the present invention there is provided a method for storing and retrieving digital media, comprising the steps of:

receiving a digital media from a sending device of a user by a service provider that was sent over a communication network, the service provider having a database having a plurality of customer accounts for storing of digital media with respect to the associated customer accounts;

examining a message associated with the digital media that has been forwarded from the first device so as to obtain a sender ID;

searching the database to determine if the ID is associated with one of the customer accounts;

forwarding the digital media to the database if the associated customer account exists and associating the digital images with the associated customer account; and

establishing a temporary account if no associated customer account exists and storing the digital media in the database and associating the stored digital media with the temporary account; and associating a PIN with respect to the temporary account and forwarding the PIN to the user for use in accessing the stored digital media.

In accordance with another aspect of the present invention there is provided a computer software program for use on a computer of a service provider, the computer associated with a database having a plurality of customer accounts, the software program when loaded on the computer allows the computer to perform the steps of:

receiving a digital media from a sending device of a user over a communication network and storing the digital media on a database, the database having a plurality of customer accounts, the database capable of storing and associating digital media with respect to each of the customers accounts;

examining a message associated with the digital media that has been forwarded from the first device so as to obtain a sender ID;

searching the database to determine if the ID is associated with one of the customer accounts;

forwarding the digital media to the database if the associated customer account exists and associating the digital images with the associated customer account; and

establishing a temporary account if no associated customer account exists and storing the digital media in the database and associating the stored digital media with the temporary account; and associating a PIN with respect to the temporary account and forwarding the PIN to the user for use in accessing the stored digital media.

These and other aspects, objects, features and advantages of the present invention will be more clearly understood and appreciated from a review of the following detailed description of the preferred embodiments and appended claims and by reference to the accompanying drawings.

### BRIEF DESCRIPTION OF THE DRAWINGS

In the detailed description of the preferred embodiments of the invention presented below, reference is made to the accompanying drawings in which:

FIG. 1 is a schematic diagram of a system for operating in accordance with the present invention;

FIG. 2 is a flow chart illustrating one process for submitting and storing images at a service provider in accordance with the present invention; and

FIG. 3 is a flow diagram for accessing the images that have been stored on the service provider to which images have been forwarded in accordance with the present invention.

### DETAILED DESCRIPTION OF THE INVENTION

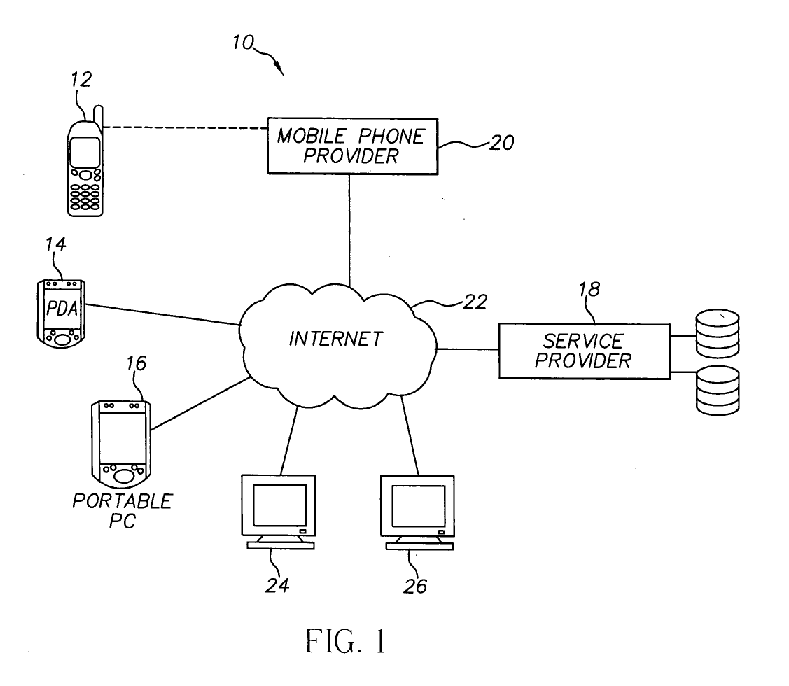

Referring to FIG. 1 there is illustrated a system 10 in accordance with the present invention. The system 10 includes sending devices 12, 14 and 16 which are capable of wireless transmission of data to an on-line image service provider 18. In the particular embodiment illustrated, the sending device 12 is a wireless phone digital camera (often referred to as a phone cam); sending device 14 is PDA (personal digital assistant) and sending device 16 is a portable personal computer (PC). Service provider 18 is an on-line service provider such as Ofoto that provides goods and services with respect to images and other personal digital media (such as video clips, audio clips, and text) stored at their site for a plurality of customers. The image service provider 18 typically has a database of customers each having their customer account information and associated ID(s). An example of the various services and products that may be offered by the service provider 18 is the storage of digital images, the ability to share images with others over the Internet, the providing of prints of their stored images, and providing other products having images thereon. The image provider 18 may of course provide any other desired service or goods desired.

In the particular embodiment illustrated, the phone camera 12 sends images first to a mobile phone service provider 20, (such as Sprint, Verizon), which in turns forwards the received data from the phone camera 12 over a communication network, such as the Internet, 22 to service provider 18. With respect to the PDA 14, information may be transmitted (both hard wired or wirelessly) from the PDA to other devices, for example, but not limited to, transmitting data over the Internet to the service provider 18. In a manner similar to that of PDA, portable computer 16 may communicate with the service provider 18. It is to be understood that sending devices 12, 14 and 16 may send messages wirelessly to a service provider 18 by an appropriate communication network and is not limited by the systems discussed herein. The system 10 may also include personal computers 24 and 26 that can be used by users for accessing the service provider 18 over the Internet 22.

As previously discussed, the user of a sending device 12, 14 or 16 may not be in a position or have the opportunity to set up an account with service provider 18 prior to having the need or desire to send images to the service provider. For example, if someone is at an event such as a sporting event, it may not be possible to do all of the steps necessary to set up an appropriate account and still maintain enjoyment of the event. Additionally, the individual may be so caught up with the ongoing events that there is no time to provide the appropriate dialog between the service provider and user of the device at that particular point and time to set up a customer account.

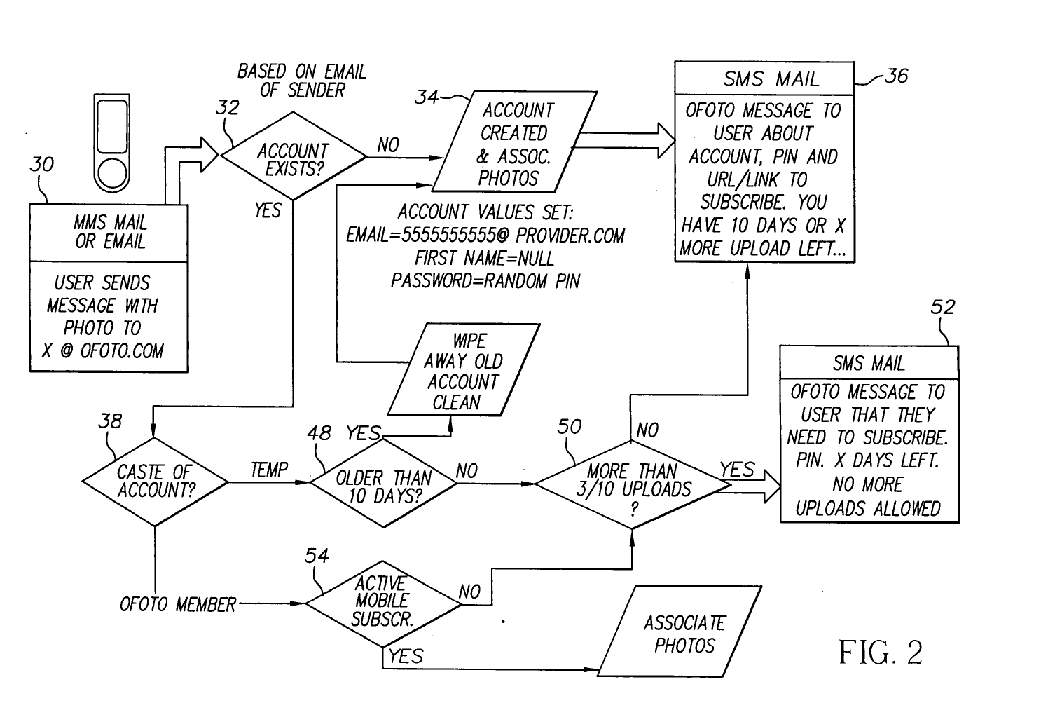

Referring to FIG. 2, there is illustrated a flow diagram on how a sending device such as camera phone 12 can forward/transmit images to the service provider 18. The initial action taken by a user of the mobile phone camera 12 would be to capture one or more images (or other digital media, such as video clips). At some point it is desirable or necessary to transmit these images to service provider 18. For example, the phone camera 18 may not have enough memory to capture another image without having to delete a currently existing image stored thereon. Thus, the first step 30 in the method, would be to transmit the images to service provider 18. In which case, an MMS (multimedia message service) message, SMS (short message service) or e-mail is composed and forwarded first to the mobile service provider 18 which in turn forwards the images to service provider 18 at step 30. By sending an MMS, SMS message or e-mail there is no need for the user of the mobile camera phone 12 to maintain active dialog with the image service provider. The MMS, SMS or e-mail forwarded to the image service provider 18 contains a unique sender ID (identification). In particular, when an e-mail or MMS or SMS message is sent from a mobile phone device, the header message typically forwarded would include either the e-mail address of the sender, the phone number of the sender, or a serial number for the device. Alternatively, a unique identifier for the sending device might be extracted from the return-address of the message, from metadata stored within the image itself, or from the body of the message. Therefore, the data that is sent to the image to provider 18 includes a transmission information message that is associated with the image that provides unique ID information with respect to the sending device or sender (or user of the device). The providing of this unique ID information is critical for allowing further access to the images stored at the image service provider 18 at a later more convenient time. Once the message has been received by the image service provider 18 at step 32, the service provider 18 determines whether an account exists that is associated with the unique ID that has been received with respect to the received associated images. If no account exists at the image service provider database, then at step 34, a temporary customer account is established by the image service provider 18. The next step 36 would be for the image service provider to send a message back to the user and/or sending device providing information about the temporary customer account that has been set up with respect to the received images. In particular, a PIN (Personal Identification Number) and a URL (Universal Resource Locator) address and/or link is forwarded back to the sending device 12 or e-mail address provided. The user of the device 12, may then use this information to access the images stored in the temporary customer account. The returned information may include information as to how to subscribe to the service provider 18. The returned information may also be displayed on the display screen provided on the sending device 12 or placed in memory for later access by the user on device 12. Additional information may be sent to the user, for example, but not limited to, that the user has a predetermined time period in which to access the images or that the user may have a particular number of uploads available with respect to that temporary customer account.

At step 32, if it is determined that some type of account exists with regard to the customer based on the unique ID information, the service provider then determines at step 38 as to the type of an account that exists. For example, whether or not the user has a standard account or a temporary account. If it is a temporary account for example, such as the one created at step 34, at the next step 48, it is determined whether or not the temporary account is older than a predetermined number of days. In a particular account, it is determined whether the account is older than 10 days, in which case the user goes to step 50 to determine if more than a predetermined number of previous uploads have been provided. For example, if there is more than about 3 uploads and the user has not yet subscribed at step 52, the user is advised that they need to subscribe and that only a predetermined number of days are left wherein no more uploads will be allowed or that there are only a certain number of uploads available. However, at step 50 if the number of uploads is below a predetermined number, for example 3, then the standard message as previously sent in step 36, would be sent to the user and/or sending device. Of course, the exact figures of 10 days and 3 uploads are unimportant—the system can be implemented with any values for these restrictions, or with no restrictions at all. Alternatively, other restriction policies can be implemented (such as a limitation on total megabytes of storage space, a limitation on number of images uploaded within a particular time period, or any other policy that can be imagined).

Going back to step 38, if is determined that the unique ID can be associated with a standard account, then at step 54 it is determined whether or not the account is an active subscriber to a service plan that allows for mobile-originated uploads. If yes, the digital images (or digital media) are associated with respect to the appropriate customer account. If a subscription to an appropriate service plan has not been set up, the customer is sent back to step 50 wherein the same questions are asked as previously discussed at this step.

The images may be sent by the user on the sending device by activating a special key or keys that have been programmed into the device either manually or by software that have been placed thereon. In particular, the e-mail address that is used for uploading the images can be pre-programmed into the address book of the sending device, or this address can be inserted using an appropriate over-the-air provisioning mechanism (either automatically, or upon the request of the user). The forwarding of the images may also be automatic without the need or assistance of the user. For example if the storage capacity of the mobile device 12 reaches a predetermined level, the sending device 12, as preprogrammed could initiate the transfer of the digital stored images to the service provider 18. The service provider 18 would of course still send the reply messages for use in later accessing the digital images stored at the image provider 18. This message could be in the form of an e-mail, or MMS message.

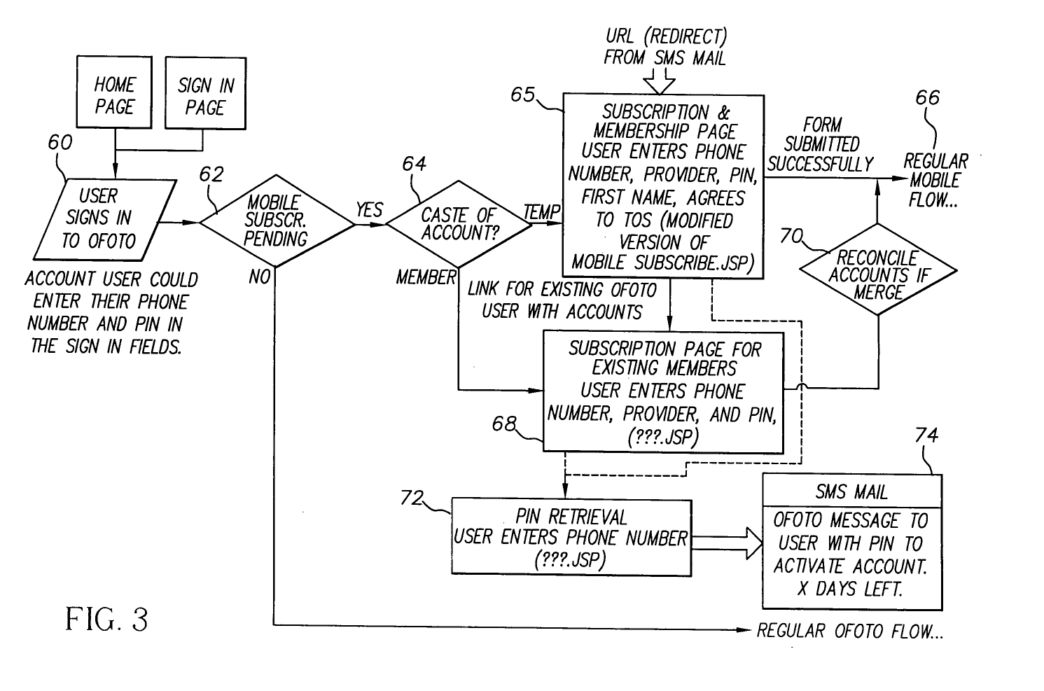

Referring to FIG. 3, there is illustrated a flow diagram wherein the user/sender at a later convenient time would access the images at the image service provider 18 over the Internet (or other appropriate communication network). The sender at step 60 would access the image provider site over the Internet 22 and go through the normal sign in page and/or home page of the service provider 18. It would be determined at step 62 if the accessing user has an account which has been used for these mobile-originated uploads through use of the unique ID. If the answer is no, the user goes to the regular IP service provider normal workflow. If it is determined that the accessing user is associated with a mobile subscriber account at step 62, it would then be determined at step 64 what type of an account exists. At step 64, if the ID is associated with a temporary account, the user is forwarded to step 65 where the user becomes a mobile subscriber. In this case, since there is only a temporary account, the PIN number must be provided by the user and it must agree with the unique ID that was previously provided with respect to the sending device. If a successful comparison is found, the user is forwarded on to step 66 wherein the user is sent on to the normal image provider work flow for a new mobile subscriber. At step 65 it is determined if the user/customer has an existing mobile account not associated with the ID and PIN used to get to step 65 the previously-uploaded images are associated with the existing account at step 68. The two accounts are reconciled at step 70 and the user proceeds to step 66 as previously described. If at step 65 the user does not wish to set up a mobile imaging account at that time, the images may be accessed at step 72 by the user, however at step 74, a message is generated advising the user that they have a certain number of days to activate the mobile imaging account, after which the mobile imaging account will be deleted.

If at step 64 it is determined from the ID that the user does have an existing mobile customer account, the user is sent to step 68 where the user would enter the appropriate PIN and unique ID to access the account. For example, the e-mail address or phone number of the sending device and the PIN number that has been provided by the user. Once this has been provided, the user is then sent on to step 66 where normal services are provided by service provider 18.

With regard to PDA and mobile portable PC 16, the process is essentially the same except instead of working through a mobile phone service provider, they are directly hooked up with the image provider 18 through the Internet, in which case the e-mail address of the sending devices may be used for the unique ID. It is of course understood that the unique ID for identifying the sending device or user may be any unique device that may be associated therewith.

It can be seen that a user can send digital images to an image provider without an existing customer account in a quick an efficient manner, yet provide the controlled access to the images at a later point in time. In this way, the customer need not interrupt his or her current activity to send or remove images from a device that is currently being used. In addition, images can be automatically sent to the image provider when required by the sending device without having set a customer account, thereby avoiding the inadvertent deletion of images.

It is to be understood that various modifications and changes may be made without departing from the scope of the present invention, the present invention being defined by the following claims.

### PARTS LIST

10 system

12 sending device

14 sending device

16 sending device

18 on-line image service provider

20 mobile phone service provider

22 Internet

24 personal computer

26 personal computer

30 step

32 step

34 step

36 step

38 step

48 step

50 step

52 step

54 step

60 step

62 step

64 step

65 step

66 step

68 step

70 step

72 step

74 step

1. A method for storing and retrieving digital media, comprising the steps of:
receiving a digital media from a sending device of a user by a service provider that was sent over a communication network, said service provider having a database having a plurality of customer accounts for storing of digital media with respect to said associated customer accounts;
examining a message associated with said digital media that has been forwarded from said first device so as to obtain a sender ID;
searching said database to determine if said ID is associated with one of said customer accounts;
forwarding said digital media to said database if said associated customer account exists and associating said digital images with said associated customer account; and
establishing a temporary account if no associated customer account exists and storing said digital media in said database and associating said stored digital media with said temporary account; and associating a PIN with respect to said temporary account and forwarding said PIN to the user for use in accessing said stored digital media.

2. The method according to claim 1 wherein the PIN is sent to the user via the sending device.

3. The method according to claim 2 wherein said sending device comprises a wireless device

4. The method according to claim 3 wherein said wireless device is digital media capture device.

5. The method according to claim 3 wherein said wireless device comprises a phone camera.

6. The method according to claim 1 wherein said sending device comprise a personal computer.

7. The method according to claim 1 wherein said ID comprises at least one of the following:
phone number of said sending device;
e-mail address of the sending device;
phone number of the user;
e-mail address of the user;
unique ID of the sending device;
unique ID of the user.

8. The method according to claim 1 wherein a text message including said PIN number is sent to the sending device.

9. The method according to claim 1 wherein a text message including said PIN number is sent to the user.

10. The method according to claim 1 wherein said user uses said PIN number for accessing said digital media stored in said temporary account.

11. The method according to claim 10 wherein said user establishes a permanent customer account.

12. The method according to claim 1 wherein said forwarding of said digital media is accomplished by use of e-mail.

13. The method according to claim 1 wherein said forwarding of said digital media is accomplished by use of multimedia message service (MMS).

14. The method according to claim 1 wherein said digital media is sent to an e-mail address of said service provider.

15. The method according to claim 1 wherein said digital media is sent over at least two different times.

16. The method according to claim 1 wherein said message being examined includes a message header.

17. The method according to claim 1 wherein said digital media comprises a digital image.

18. The method according to claim 1 wherein said digital media comprises a video clip.

19. The method according to claim 1 wherein said digital media comprises text.

20. A computer software program for use on a computer of a service provider, said computer associated with a database having a plurality of customer accounts, said software program when loaded on said computer allows said computer to perform the steps of:
receiving a digital media from a sending device of a user over a communication network and storing said digital media on a database, said database having a plurality of customer accounts, said database capable of storing and associating digital media with respect to each of said customers accounts;
examining a message associated with said digital media that has been forwarded from said first device so as to obtain a sender ID;
searching said database to determine if said ID is associated with one of said customer accounts;
forwarding said digital media to said database if said associated customer account exists and associating said digital images with said associated customer account; and
establishing a temporary account if no associated customer account exists and storing said digital media in said database and associating said stored digital media with said temporary account; and associating a PIN with respect to said temporary account and forwarding said PIN to the user for use in accessing said stored digital media.

21. A computer software program according to claim 20 wherein the PIN is sent to the user via the sending device.

22. A computer software program according to claim 21 wherein said sending device comprises a wireless device

23. A computer software program according to claim 22 wherein said wireless device is digital media capture device.

24. A computer software program according to claim 22 wherein said wireless device comprises a phone camera.

25. A computer software program according to claim 20 wherein said sending device comprise a personal computer.

26. A computer software program according to claim 20 wherein said ID comprises at least one of the following:
phone number of said sending device;
e-mail address of the sending device;
phone number of the user;
e-mail address of the user;
unique ID of the sending device;
unique ID of the user.

27. A computer software program according to claim 20 wherein a text message including said PIN number is sent to the sending device.

28. A computer software program according to claim 20 wherein a text message including said PIN number is sent to the user.

29. A computer software program according to claim 20 wherein said user uses said PIN number for accessing said digital media stored in said temporary account.

30. A computer software program according to claim 29 wherein said user establishes a permanent customer account.

31. A computer software program according to claim 20 wherein said forwarding of said digital media is accomplished by use of e-mail.

32. A computer software program according to claim 20 wherein said forwarding of said digital media is accomplished by use of multimedia message service (MMS).

33. A computer software program according to claim 20 wherein said digital media is sent to an e-mail address of said service provider.

34. A computer software program according to claim 20 wherein said digital media is sent over at least two different times.

35. A computer software program according to claim 20 wherein said message being examined includes a message header.

36. A computer software program according to claim 20 wherein said digital media comprises a digital image.

37. A computer software program according to claim 20 wherein said digital media comprises a video clip.

38. A computer software program according to claim 20 wherein said digital media comprises text.
